(19) United States
(12) Patent Application Publication
(10) Pub. No.: US 2023/0152485 A1
(43) Pub. Date: May 18, 2023

(54) METHOD FOR MODELING THE DAMAGE ZONE OF FAULTS IN FRACTURED RESERVOIRS

(71) Applicant: Petróleo Brasileiro S.A. - Petrobras, Rio de Janeiro (BR)

(72) Inventors: Bruno Raphael Barbosa Melo De Carvalho, Rio de Janeiro (BR); João Carlos Leal Segreto Menescal, Macae (BR); Romulo De Campos Stohler, Rio de Janeiro (BR)

(21) Appl. No.: 17/984,692

(22) Filed: Nov. 10, 2022

(30) Foreign Application Priority Data
Nov. 12, 2021 (BR) 10 2021 022894 6

(51) Int. Cl. G01V 99/00

(52) U.S. Cl. CPC G01V 99/005

(57) ABSTRACT

The present invention proposes a method to represent seismic fault damage zones and fracture density in the geological models of reservoirs in a simple, agile and automated way, so that it can be easily replicated by geologists in any production design. It was developed as a group of workflows, inserted in the commercial software Petrel, widely used in the company for the 3D numerical modeling of reservoirs.

### FIELD OF THE INVENTION

The present invention is related to the integral application in designs of naturally fractured reservoirs that contain a built geological and/or simulation model, considering any lithological type, where the strain processes are associated with the formation and evolution of geological faults.

### DESCRIPTION OF THE STATE OF THE ART

Currently, the reservoir teams that manage the Pre-Salt fields need geocellular numerical models of double porosity and double permeability, which aim at representing the flow of fluids in a fractured medium.

These models are used in the reserve calculations and in the production prediction of the wells, being necessary to adjust production history data, dynamic tests and water arrival at the producing wells. However, the methodological approach previously used for the spatial distribution of fractures in numerical models demanded a lot of dedicated time from specialized professionals with manual and repetitive tasks, in addition to hindering an adequate incorporation of the most current structural geology concepts for the representation of the most strained regions associated to seismic fault zones. This poorly optimized process causes problems for model validation and decreases the reliability of production predictions. The correct characterization of these fault zones is of great importance in production management, since the structural domains have different mechanical, hydraulic and petrophysical properties, presenting a flow behavior very different from the unstrained rock. These strained regions around geological faults, called damage zones, can act as barriers or conduits to the flow of fluids in reservoir rocks.

Before the fault damage zone representation program was developed, the distribution of fractures in the models was not standardized and involved several manual and repetitive steps. In most cases where fracture modeling was performed, a fixed value of distance from the damage zone in relation to the faults was used, limiting or exaggerating the occurrence of fractures in these regions.

However, this approach does not obey structural geology criteria and does not take into account the natural laws of correlation of structural properties that govern the most strained zones. In other cases, mainly for very small damage zones and models with very coarse grids, these more strained regions associated with the faults were not even represented in the geological models, generating numerical models incapable of correctly representing the flow of fluids in naturally fractured reservoirs. These previous methods could lead to incorrect production predictions, with major negative impacts on the value creation of production development designs, including in the pre-salt fields.

The document Computational Modeling Of Formation And Evolution Of Damage Zones in Reservoir Scale discloses numerical models based on the finite element method (FEM) to study the structural evolution of damage zones at reservoir scale. Sensitivity analyzes were performed varying the mechanical properties of intact rocks in order to verify their impact on the structural evolution of the damage zone.

Document US20180321404A1 discloses a subsurface formation that can be modeled by calculating an iso-surface for a higher iso-value from a three-dimensional stratigraphic function for a volume of interest in the subsurface formation, calculating a first and a second strike traces following an iso-surface topography computed on the respective first and second sides of a fault in the volume of interest, extracting seismic data along the first and second strike traces, correlating the seismic data extracted along the first and second strike traces, and computing a fault displacement vector for the fault from the correlated extracted seismic data along the first and second strike traces.

Document US20180031720A1 discloses a method for generating a subsurface model with one or more objects for a subsurface region. The method comprises: obtaining a volumetric representation associated with a subsurface region; obtaining a plurality of objects associated with the subsurface region, wherein the plurality of objects comprises one or more faults, horizons and any combination thereof; inserting the plurality of objects into the volumetric representation, wherein the volumetric representation comprises a plurality of blocks; calculating a value for each of the plurality of blocks based on an object priority function (e.g. signed distance or priority field); constraint calculation; removing one or more blocks from the plurality of blocks based on constraints and the object priority function to create the watertight model; and outputting the watertight model.

Both the anteriorities presented do not disclose the strain intensity modeling based on the initial fracture density data, damage zone thickness, distance from the fault and fracture density outside the damage zone, as will be described below.

In view of the difficulties present in the above-mentioned state of the art, and for solutions for modeling the damage zone of faults in fractured reservoirs, there is a need to develop a technology capable of performing effectively and that is in accordance with the environmental and safety guidelines. The above-mentioned state of the art does not have the unique features that will be presented in detail below.

### Objective of the Invention

It is an objective of the invention to provide an approach and management with respect to fracture models developed in naturally fractured reservoirs associated with faults.

It is further an objective of the invention to increase the field recovery factor and more effective prediction of the production curve.

### BRIEF DESCRIPTION OF THE INVENTION

The present invention proposes a method to represent seismic fault damage zones and the fracture density in the geological models of reservoirs in a simple, agile and automated way, so that it can be easily replicated by geologists in any production design. It was developed as a group of workflows, specifically inserted in the commercial software Petrel for the 3D numerical modeling of reservoirs, but it could be applied in other software, in which the steps would be operationalized according to the characteristics and capacity thereof.

### BRIEF DESCRIPTION OF DRAWINGS

The present invention will be described in more detail below, with reference to the attached figures which, in a schematic way and not limiting the inventive scope, represent examples of its embodiment. In the drawings, there are:

FIG. 1 schematically illustrates a damage zone and its main elements (modified from Mayolle et al., 2019). Main elements: (1) geological fault; (2) fault slip (displacement); (3) damage zone thickness; (4) damage zone boundary; (5) frequency of structures in the damage zone; (6) cumulative frequency curve;

FIG. 2 illustrates the relationship between slips from geological faults and the thickness of damage zones grouped by different types of rocks;

FIG. 3 illustrates the frequency of distribution of structures observed in the literature for regions close to a geological fault (arrow);

FIG. 4 illustrates the exemplification of the concepts for the definition of the variation of the fracture density along the dip and direction of the geological fault (10) that will be represented in the geological model for two different scenarios, (A) larger slips and (B) minor slips;

FIG. 5 illustrates damage zones modeled in a geological model, separated by maximum (A), base (B) and minimum (C) scenarios for the damage zone thickness, horizontal (i) and vertical (ii) sections in the same section according to the marked line. The dark gray regions represent the damage zones modeled for each fault (white arrow) on the geological grid;

FIG. 6 illustrates petrophysical properties, permeability (A) and porosity (B), populated in the previously represented damage zone (FIG. 5), in horizontal (i) and vertical (ii) sections, following the distribution pattern of structures in the damage zone of each fault (white arrow), in the geological grid, according to FIG. 5.

### DETAILED DESCRIPTION OF THE INVENTION

There follows below a detailed description of a preferred embodiment of the present invention, by way of example and in no way limiting. Nevertheless, it will be clear to a technician skilled on the subject, upon reading this description, possible further embodiments of the present invention still comprised by the essential and optional features below.

The entire method created was developed and tested in a synthetic geological model, and after this step, it was applied in pre-salt and post-salt carbonate reservoirs according to the needs of each field. The developed method uses robust conceptual models and fault property correlation algorithms obtained from the parameterization of analogous outcrops, to represent the damage zones of seismic faults and the fracture density in the geological models of reservoirs in a simple, agile and automated way, so that it can be easily replicated by geologists in any production design. It was developed as a group of workflows, inserted for convenience in the software Petrel, but it can be applied to other commercial or free software that has the capacity to perform numerical simulations in 3D finite element models, presenting a unique and standardized workflow for this activity, improving the management of development designs in naturally fractured reservoirs, with the potential to increase the recovery factor of the fields.

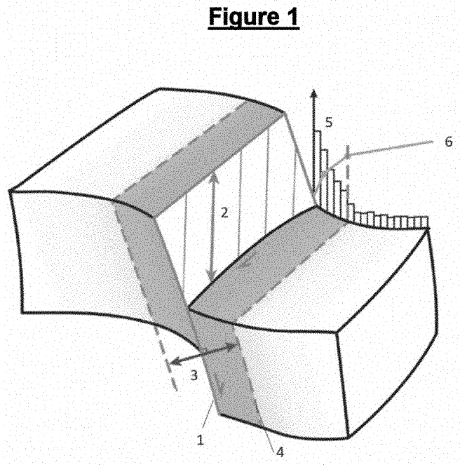

The characterization of the damage zone aims at describing, by means of structural parameters, the distribution of structures around the geological faults, and serve as a delimiter for other approaches in geological modeling. FIG. 1 shows a conceptual model for the geological fault damage zone.

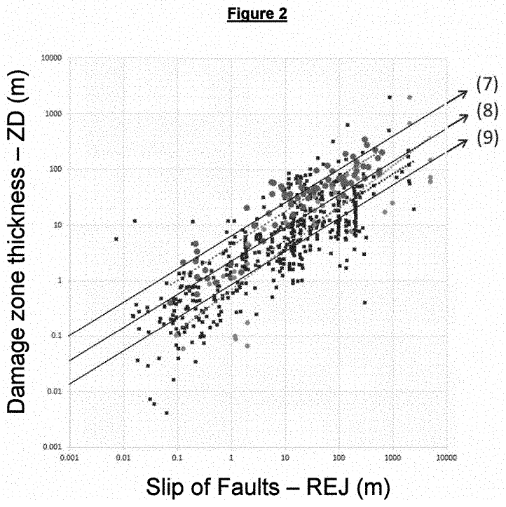

The method used is based on the analysis of the mapped seismic faults, considering the scale relationships between the elements associated with the faults, such as the relationship between slip and damage zone (FIG. 2) that will define a volume of rock in the geological model around the faults, and patterns of spatial distribution of fractures in these zones (FIG. 3) that will help in the creation of the porosity and permeability model in the previously defined damage zone.

For this purpose, some algorithms are used that represent these structural characteristics:

ZD=a×REJ^{b} (Equation 1)

DF=DFi−c×ln(DIST) (Equation 2)

where ZD is the thickness of the damage zone; REJ is the seismic fault slip; a and b are constants. Where DF is the fracture density; DFi is the initial value of the fracture density profile; c is the decay constant of the fracture density values; DIST is the distance to the fault.

At the outer boundary point of the damage zone, DF will be equal to the value of the region outside the damage zone (DFbg) and DIST will be equal to ZD. In this way, for each value of DFi and ZD used, it will be possible to calculate the value of c and thus the DF function. So, we have:

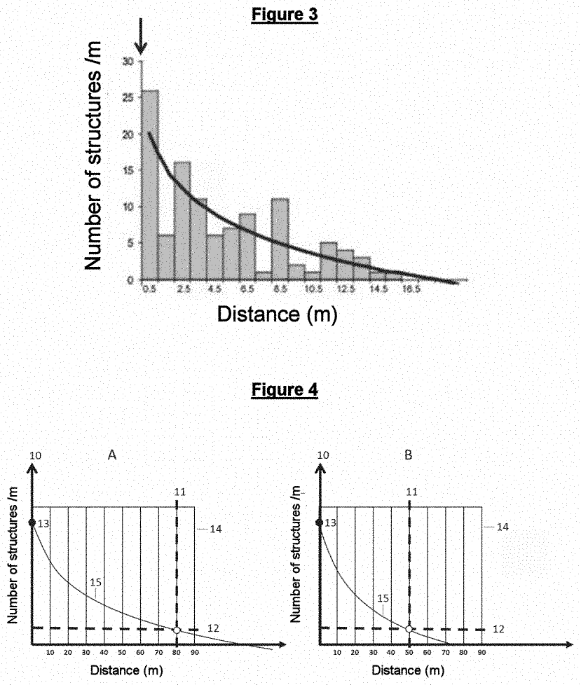

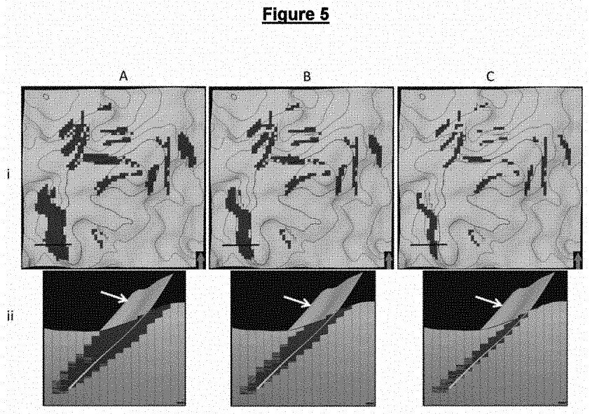

c=−(DFbg−DFi)/ln(ZD) (Equation 3)

where DFbg is the fracture density value at the outer boundary of the damage zone; ZD is the distance from the fault at the outer boundary of the damage zone. FIG. 4 exemplifies these conceptual relations as mentioned above.

In FIG. 2, it is possible to see the relation between slips of geological faults and the thickness of damage zones grouped by different types of rocks, data compiled from several works in the literature. Each correlation line between the variables defines equation 1. In this way, each line defines a scenario for the representation of the damage zone, maximum (7), average (8) and minimum (9) scenarios.

In FIG. 4, it is possible to see the exemplification of the concepts for the definition of the variation of the fracture density along the dip and direction of the geological fault (10) that will be represented in the geological model for two different scenarios, (A) larger and (B) minor slips. Where (11) is the distance from the fault at the outer boundary of the damage zone (ZD); (12) is the fracture density value at the outer boundary of the damage zone (DFbg); (13) is the initial value of the fracture density profile (DFi); (14) is the size of the grid in the geological model; (15) equation representing the decay curve of structure values (equation 3).

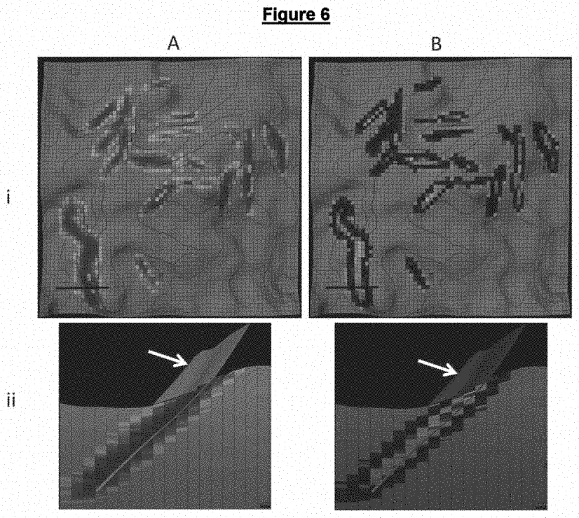

From this approach and using the proposed method, it was possible to represent these strained and complex zones in geological models, and their representation through scenarios (FIGS. 5 and 6).

In addition, with the fracture density calculated, the direction and dip angle of the geological faults and the input geological parameters, the Petrel processes are used to generate a network of discrete fractures (DFN) and later transfer of permeability and porosity properties to the model. This result can be directly used for 2PHI/1K or 2PHI/2K simulation of fractured reservoirs.

The method is performed as follows:
1. Damage Zone Modeling and Fracture Intensity Modeling. First, a modeling grid and a group of previously interpreted geological faults are selected. From there, the slip for faults is generated and converted into fault points. These slip points serve as the basis for generating regular fault surfaces and calculating dip angle and direction properties. Subsequently, these fault data are transferred to the grid and extrapolated perpendicularly in relation to each fault, each of these structures being treated individually throughout the process. The distance in each grid cell from the points that make up the faults is also calculated. Next, based on data compiled from the literature, parameters and correlation functions are defined for initial fracture density (DFi) (Equation 2), damage zone thickness versus slip (Equation 1) and fracture density outside the damage zone (background). These parameters and correlations are independently varied by different facies populated in the grid, in this way, there can be considered the effect of different types of rocks on fracturing and formation of the thickness of the modeled damage zone. With these generated data, the observed pattern of logarithmic decay is used for the fracture density data from the fault position, which has a maximum value near the fault (DFi) and gradually decreases as it moves orthogonally away from the fault. By correlating and setting the values of initial fracture density (DFi), damage zone thickness and fracture density outside the damage zone (Equation 03), the curve pattern is automatically updated, changing the result along the grid cells and representing the spatial variation of the damage zone thickness and fracture intensity. To avoid the problem of representativeness of the results associated only with the center of the grid cells, the method of calculating the integral of the fracture intensity curve is used, considering the effect of the grid direction in relation to the direction of each fault. At the end, damage zones are generated in the modeling grid with maximum dimensions where the fault displacement is greater and spatially following the variations of this displacement, as well as the values of direction, dip direction and intensity of occurrence of fractures are generated in each of these damage zones, but varying by grid cell. Considering the geological uncertainties inherent to the definition of the input parameters, three distinct scenarios of damage zone dimension and fracture intensity are generated as results.
2. Program and Interface (Software)—a program was built within the platform Petrel that integrates the previous methods with Petrel internal modules to model discrete and upscale fractures. In addition to automating processes, it also has an interface focused on making it easier for users to use.

The program needs 2 types of input data. A grid loaded in the Petrel that contains faults (in stair-step or pillar grid format) and scale correlation and fracture modeling parameters that can be filled in with conceptual material and complementary data. With the grid provided, the fault slip is calculated and individually converted into slip points and transferred to a folder in the input window. There is no need for the grid, which contains the faults, to be the same grid that will receive the created properties. These slip points are the basis of the entire process. Using processes from the Petrel software itself, surfaces and properties of direction and dip angle are generated. Everything is converted into points with slip and dip.

The next step is performed on the grid, where the properties of slip, direction and dip angle are transferred and extrapolated. These properties are distributed and organized within folders on the grid. The distance to each fault is also calculated. After the previous step, the mentioned equations and correlations are used to estimate the damage zone width and fracture density. This process is done for each fault separately and with results organized in folders.

The program works with 3 parameter scenarios to better deal with geological uncertainties. Thus, properties are generated that show both visually and quantitatively the thickness of the damage zone, as well as the density of fractures and crossing zones of structures. Accumulated and summed properties of all faults are also generated to facilitate visualization and understanding, as well as normalized properties to use as a trend. Fracture density and fault attitude properties are used in Petrel fracture modeling module. This is done by fault to have better control and have the effect of structure crossing. In this step, 3 different DFN (Discrete Fracture Network) scenarios are generated in order to work with the uncertainty of the data.

Finally, the fracture properties are scaled to the grid. These properties are also organized within the result folder with 3 uncertainty scenarios. Due to known simulation problems due to low fracture porosity, an option is offered to normalize this porosity between a user-defined minimum and maximum.

In addition to the mandatory steps of the program, some extra options are also provided that help the user to organize and classify their data and generate useful inputs. It is possible to classify faults in domains based on their average direction, as well as to run an analysis that evaluates each fault and list data of maximum length, maximum slip, average dip angle and direction and generate the lineament that corresponds to this maximum length of the fault.

1. A method for modeling the damage zone of faults in fractured reservoirs, characterized in that it characterizes the damage zone (Damage zone characterization); models the strain intensity (Strain intensity modeling); integrates said damage zone and strain intensity modeling with internal modules of an upscale and discrete fracture model generation software.

2. The method according to claim 1, characterized in that the integration requires 2 types of input data, a grid loaded in the software containing faults (in stair-step or pillar grid format) and the parameters of scale correlations and modeling of fractures.

3. The method according to claim 2, characterized in that, after the grid is loaded, it calculates the fault slip and converts them individually into slip points and transferred to a folder in the input window.

4. The method according to claim 1, characterized in that it generates surfaces and properties of direction and dip angle and converts into points with slip and dip.

5. The method according to claim 1, characterized in that it calculates the distance to each fault.

6. The method according to claim 1, characterized in that it uses the mentioned equations (1, 2 and 3) and correlations to estimate the damage zone width and the fracture density.

7. The method according to claim 1, characterized in that it shows both visually and quantitatively the width of the damage zone, as well as the density of fractures and structure crossing zones.

8. The method according to claim 1, characterized in that it generates accumulated and summed properties of all faults, as well as normalized properties to use as a trend.

9. The method according to claim 1, characterized in that it generates 3 different DFN (Discrete Fracture Network) scenarios in order to work with data uncertainty.

10. The method according to claim 1 characterized in that it performs scale transfer of fracture properties to the grid with 3 uncertainty scenarios.

11. The method according to claim 1, characterized in that, due to the low porosity of fractures, an option is offered to normalize this porosity between a minimum and a maximum defined by the user.

12. The method according to claim 1, characterized in that it classifies faults in domains based on the average direction thereof; it runs evaluation analysis of each fault and lists data of maximum length, maximum slip, average dip angle and direction and generates the lineament that corresponds to this maximum fault length.
